(19) United States
(12) Patent Application Publication
(10) Pub. No.: US 2004/0239867 A1
(43) Pub. Date: Dec. 2, 2004

(54) Method for manufacturing liquid crystal display

(75) Inventors: Yamashita Hidefumi, Tainan County (TW); Cheng Che Pan, Tainan County (TW)

Correspondence Address: Finnegan, Henderson, Farabow,, Garrett & Dunner, L.L.P., 1300 I Street, N.W., Washington, DC, 20005-3315, US

(73) Assignee: Chi Mei Optoelectronics Corp.

(21) Appl. No.: 10/446,935

(22) Filed: May 29, 2003

(51) Int. Cl. G02F 1/13

(52) U.S. Cl. 349/187

(57) ABSTRACT

A method for manufacturing a liquid crystal display is disclosed. The liquid crystal display includes a liquid crystal material between opposing first and second substrates, spacers for maintaining a cell gap and a plurality of first and second color filters. The method includes the steps of: (a) estimating an optimum quantity of the liquid crystal material by measuring the height of the spacers, the thickness difference between the first color filters and the second color filters, and the distance between two adjacent color filters; (b) applying an adhesive onto the periphery of the first substrate or the second substrate; (c) dispensing the liquid crystal material to the first substrate, wherein the quantity of the dispensed liquid crystals is controlled based on the estimated optimum quantity; (d) superposing the second substrate upon the first substrate; and (e) curing the adhesive to obtain the liquid crystal display.

### BACKGROUND OF THE INVENTION

1. Field of the Invention

The present invention relates to a method for manufacturing a liquid crystal display (LCD) and, more particularly, to a method for manufacturing a liquid crystal display with liquid crystal (LC) material sealed between two substrates using a one drop fill (ODF) process.

2. Description of the Related Art

Liquid crystal display typically comprises two glass substrates oppositely positioned and a liquid crystal layer interposed therebetween. Specifically, the glass substrates are assembled by the following steps. First, an adhesive seal material is applied, usually by either silkscreening or screen printing. An opening is left in the seal for liquid crystal (LC) material injection in the subsequent process. After the adhesive is applied, spacers are provided on one of the substrates to maintain a precise cell gap (between 3-10 micrometers) between the two substrates. Typically, the spacers are formed by spraying glass or plastic beads on one of the substrates or by using resin to fabricate photo-spacers onto one of the substrates via the photolithography process. The substrates are then aligned and laminated by heat and pressure to complete the cross-linking of the polymer. After the assembling process is completed, the assembled glass substrates are cut into individual LCD cells. Then, the liquid crystal material is injected into the LCD cell by vacuum injection (vacuum injection method). The opening that was left open for this injection is sealed with the same type of resin and cured.

The process of one drop fill (ODF) comprises the steps of applying an adhesive onto the entire periphery of the first substrate, dropping the liquid crystal material to the first substrate, superposing the second substrate upon the first substrate, and curing the adhesive.

In comparison with vacuum injection method used widely in manufacturing liquid crystal displays, the ODF process significantly reduce costs for manufacturing liquid crystal displays and improve productivity on a mass production basis because, firstly, it significantly reduces the amount of LC material to be used and, secondly, it decreases the time required for injecting LC material. Therefore, a strong demand exists for the use of the ODF process in manufacturing liquid crystal displays.

According to the ODF process, a predetermined quantity of LC material are dispensed on a substrate using a liquid crystal dispenser. However, a problem can arise in that the quantity of the LC material in the LCD cell become excessive or insufficient because of variation of the cell volume defined between the substrates. A shortage of the quantity of the LC material in the LCD cell results in so-called voids observed in the LCD cell. Gravity mura (wide-area pixel defect) can be observed when the quantity of the LC material in the LCD cell is excessive. Any liquid crystal display having such problems of voids or gravity mura is regarded as defective.

Since the cell volume is likely to vary from cell to cell, a situation can occur in which a quantity of the LC material set to be dispensed for a certain LCD cell is excessive or insufficient for another LCD cell. For this reason, the optimum quantity of the LC material to be dispensed can be different for different LCD cells.

### SUMMARY OF THE INVENTION

Therefore, it is an object of the present invention to provide a method for manufacturing a liquid crystal display with liquid crystal (LC) material sealed between two substrates using a one drop fill (ODF) process in which LC material can be dispensed in an optimum quantity on one substrate.

To achieve the above listed and other objects, a step of estimating an optimum quantity of the LC material is conducted in advance by measuring a flatness distribution of the substrate on which spacers and color filters are provided. The flatness distribution of the substrate is estimated by measuring the height of the spacers, the thickness difference between two kinds of color filters, and the distance between two adjacent color filters. After an adhesive is applied onto the peripheral region of one substrate, the LC material is dispensed to the other substrate. It is noted that the dispensed quantity of LC material is controlled based on the optimum quantity the LC material. After that, one substrate is superposed upon the other substrate, and the adhesive is cured by application of a suitable radiation thereby obtaining the liquid crystal display.

In one embodiment of the present invention, only three kinds of color filters, i.e., first, second and third color filters, are provided in the liquid crystal display. If all of the spacers are provided on the first color filters, the optimum quantity of the liquid crystal material is proportional to the value calculated by the equation:

H+⅓*((T1−T2)+(T1−T3))

where H is equal to the average of the measured heights of the spacers, T1 is equal to the average thickness of the first color filters, T2 is equal to the average thickness of the second color filters, T3 is equal to the average thickness of the third color filters.

To achieve the above listed and other objects, another step of estimating an optimum quantity of the LC material is conducted in advance by measuring a cell volume defined between the substrates. The cell volume of the substrate is estimated by measuring the height of the spacers, the thickness difference between two kinds of color filters, and the distance between two adjacent color filters.

In another embodiment of the present invention, only three kinds of color filters, i.e., the first, second and third color filters in the shape of rectangle are provided in the liquid crystal display. If all of the spacers are provided on the first color filters and if only one spacer is provided on each of the first color filters, the optimum quantity of the liquid crystal material is proportional to the value calculated by the equation:

W1*H*L+W2*(H+(T1−T2))*L+W3*(H+(T1−T3))*L+(W13+W12+W23)*D*L−P

where W1 is equal to the average width of the first color filters, W2 is equal to the average width of the second color filters, W3 is equal to the average width of the third color filters, H is equal to the average of the measured heights of the spacers, L is equal to the average length of the color filters, T1 is equal to the average thickness of the first color filters, T2 is equal to the average thickness of the second color filters, T3 is equal to the average thickness of the third color filters, W13 is equal to the average distance between the first color filters and the third color filters, W12 is equal to the average distance between the first color filters and the second color filters, W23 is equal to the average distance between the second color filters and the third color filters, D is equal to the distance between the pair of substrates, P is the average volume of the spacers.

### BRIEF DESCRIPTION OF THE DRAWINGS

Other objects, advantages, and novel features of the invention will become more apparent from the following detailed description when taken in conjunction with the accompanying drawings.

FIG. 1 is a cross-sectional view of a portion of an LCD according to one embodiment of the present invention; and

FIG. 2 is a cross-sectional view of a portion of an LCD according to another embodiment of the present invention.

### DETAILED DESCRIPTION OF THE PREFERRED EMBODIMENT

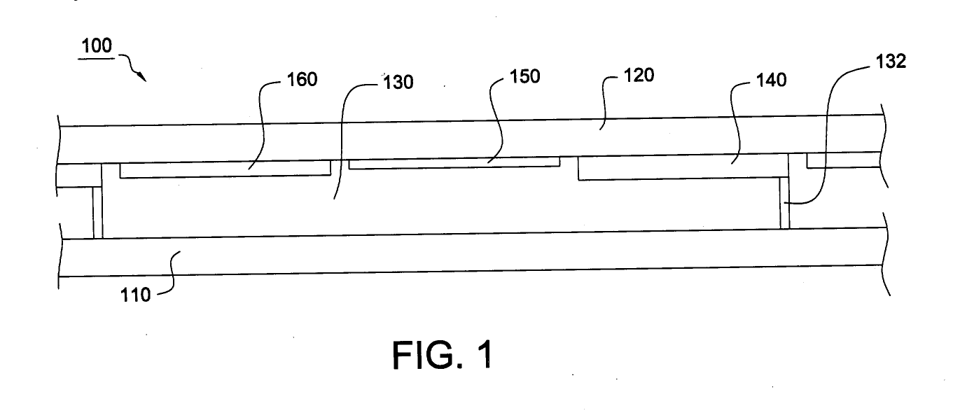

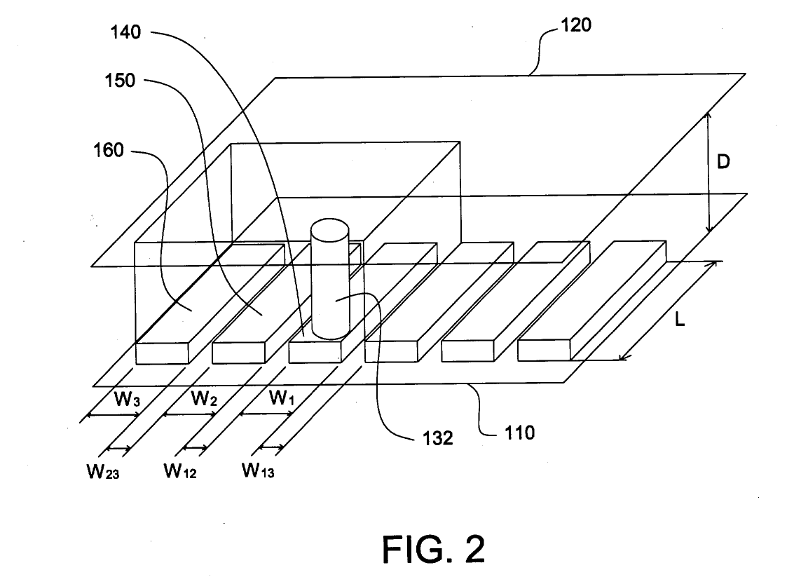

Methods for manufacturing LCDs according to the preferred embodiments of the invention will now be described with reference to FIGS. 1-2. These LCDs includes a first substrate 110 and a second substrate 120 located facing each other with LC material 130 therebetween. The first substrate 110 is typically provided with a plurality of scan bus lines (not shown) formed parallel to one another, a plurality of data bus lines (not shown) formed parallel to one another vertically to the scan bus lines, and TFTs and pixel electrodes (not shown) formed like a matrix at intersections between the scan bus lines and data bus lines. The second substrate 120 is typically provided with a light-shielding matrix (such as black matrix BM (not shown)), a plurality of first color filters (B) 140, second color filters (G) 150, and third color filters (R) 160 for displaying colors and a transparent electrode (not shown) such as an ITO electrode as a common electrode. The substrate 120 is referred to as a color filter (CF) substrate because color filters are formed, while the substrate 110 is referred to as a TFT substrate.

Spacers 132 are formed between the substrates 102, 104 for defining a cell gap between the substrates. Instead of scattered glass or plastic beads used in conventional LCD manufacturing process, the spacers 132 are formed by applying a resin layer over the entire surface of the substrate 120 with color filters provided thereon, and patterning the resin layer via a photolithography process. Since the resin layer is patterned by photolithography, all of the spacers 132 can be selectively formed on the third color filters (R) 160 (see FIGS. 1).

The LCD manufacturing methods according to preferred embodiments of the present invention employ the “one drop fill” method since it is becoming the preferred manufacturing method of LCDs. The basic steps of the “one drop fill” method are described below. First, an adhesive such as a UV curable sealant is formed in a peripheral region of one substrate, and the LC material is dropped onto the other substrate. It is noted that, in the present invention, the quantity of LC material dropped onto the substrate is controlled based on an optimum quantity estimated in advance using the methods described below. With the two substrates held spaced apart, the substrates are placed within a vacuum chamber. When the substrates are still under atmospheric pressure, the lateral positions of the two substrates are mutually aligned. The air pressure within the vacuum chamber is then reduced, and under the condition of low pressure, the two substrates are brought together so that one substrate is superposed upon the other substrate. Thereafter, the sealant is cured by application of a suitable radiation such as a ultra-violet light.

However, in the “one drop fill” method, it is necessary to dispense very accurate quantity of LC material on the substrate according to the cell volume defined between the two substrates which are already brought together. When the dispensed quantity of the LC material is insufficient to fill the space between the two substrates, voids are prone to form in the LC layer of the finished display panel. When the dispensed quantity of the LC material is excessive, gravity mura (wide-area pixel defect) is observed. Mura defects are defined as areas of illumination (pixels on the substrate) which are different, or anomalous, from the neighborhood surrounding the defect, also termed Patterned Brightness Non-Uniformity (BNU) or chrominance non-uniformity. Any liquid crystal display having such problems of voids or gravity mura is regarded as defective.

In practice, variation of the cell volume stays substantially within an acceptable range in the same production lot. However, unacceptable variation of the cell volume can occur between production lots for which resin layer forming conditions are different. For those reasons, the cell volume must be evaluated for each production lot before the LC material dispensing step is conducted in order to allow the LC material dispensing quantity to be controlled based on the evaluation result. Recently, the inventors have found during researches that the cell volume can be evaluated by measuring a flatness distribution of the substrate on which the spacers and the first and second color filters are provided. Specifically, the flatness distribution of the substrate is estimated by measuring the height of the spacers, the thickness difference between two kinds of color filters, and the distance between two adjacent color filters. It is noted that variation of the deposited thickness of the common electrode, i.e., the ITO electrode, between production lots is substantially within an acceptable range, and therefore is not considered in the evaluation of the flatness distribution of the substrate. Therefore, an optimum quantity of the LC material can be estimated by the evaluation result of the cell volume of each production lot.

The detailed evaluation method of the flatness distribution will be described as follows.

In the LCD 100 shown in FIG. 1, only the first color filters (B) 140, second color filters (G) 150, and third color filters (R) 160 are provided in the LCD 100. First, the height of the spacers and three kinds of color filters on a finished CF substrate are measured by a laser displacement gauge or a surface profiler such as Toho FP-20 profiler manufactured and marketed exclusively by TOHO TECHNICAL CORP. Then, we can calculate the average of the measured heights of the spacers (H), the average thickness of the first color filters (T1), the average thickness of the second color filters (T1), and the average thickness difference of the third color filters (T3). In this embodiment, the inventors have found that the cell volume is proportional to the value calculated by the equation:

H+⅓*((T1−T2)+(T1−T3))

In another embodiment, as shown in FIG. 2, all of the color filters 140, 150, 160 are formed in the shape of rectangle. In this embodiment, the inventors have found that the cell volume is proportional to the value calculated by the equation:

W1*H*L+W2*(H+(T1−T2))*L+W3*(H+(T1−T3))*L+(W13+W12+W23)*D*L

where W1 is equal to the average width of the first color filters, W2 is equal to the average width of the second color filters, W3 is equal to the average width of the third color filters, H is equal to the average of the measured heights of the spacers, L is equal to the average length of the color filters, T1 is equal to the average thickness of the first color filters, T2 is equal to the average thickness of the second color filters, T3 is equal to the average thickness of the third color filters, W13 is equal to the average distance between the first color filters and the third color filters, W12 is equal to the average distance between the first color filters and the second color filters, W23 is equal to the average distance between the second color filters and the third color filters, D is equal to the distance between the pair of substrates.

Furthermore, if only one spacer is provided on each of the first color filters 140, the cell volume is proportional to the value calculated by the equation:

W1*H*L+W2*(H+(T1−T2))*L+W3*(H+(T1−T3))*L+(W13+W12+W23)*D*L−P

where P is the average volume of the spacers.

However, it is not necessary to have one spacer for each pixel in practicing the present invention. For example, the LCD of the present invention may be provided with one spacer for every two pixels. In this embodiment, the cell volume is proportional to the value calculated by the equation:

W1*H*L+W2*(H+(T1−T2))*L+W3*(H+(T1−T3))*L+(W13+W12+W23)*D*L−0.5*P

Finally, since the dispensed quantity of the LC material needs to be controlled in the dispensing step based on the cell volume, the optimum quantity of the liquid crystal material is proportional to the value calculated by the above equations.

As described above, the present invention makes it possible to dispense an optimum quantity of liquid crystals onto the substrate, and it is therefore possible to perform stable mass production by eliminating display defects attributable to the voids or the excessive LC material.

Although the invention has been explained in relation to its preferred embodiment, it is to be understood that many other possible modifications and variations can be made without departing from the spirit and scope of the invention as hereinafter claimed.

What is claimed is:

1. A method for manufacturing a liquid crystal display having a liquid crystal material sandwiched between a pair of substrates, one of the pair of substrates being provided with a plurality of spacers for maintaining a cell gap between the pair of substrates and a plurality of first and second color filters, the method comprising the steps of:
estimating an optimum quantity of the liquid crystal material by measuring a flatness distribution of the substrate on which the spacers and the first and second color filters are provided;
applying an adhesive onto at least one of the pair of substrates;
dispensing the liquid crystal material to at least one of the pair of substrates, wherein the quantity of the dispensed liquid crystals is controlled based on the estimated optimum quantity;
superposing one of the pair of substrates upon the other substrate; and
curing the adhesive to obtain the liquid crystal display.

2. The method as claimed in claim 1, wherein the flatness distribution of the substrate is estimated by measuring the height of the spacers, the thickness difference between the first color filters and the second color filters, and the distance between two adjacent color filters.

3. The method as claimed in claim 1, wherein the liquid crystal display further comprises a plurality of third color filters on the substrate on which the first and second color filters are provided, and, if all of the spacers are provided on the first color filters, the flatness distribution of the substrate is estimated by measuring the height of the spacers, the thickness difference between the first color filters and the second color filters, the thickness difference between the first color filters and the third color filters.

4. The method as claimed in claim 3, wherein, if only the first, second and third color filters are provided in the liquid crystal display, the optimum quantity of the liquid crystal material is proportional to the value calculated by the equation:
H+⅓*((T1−T2)+(T1−T3))
where H is equal to the average of the measured heights of the spacers, T1 is equal to the average thickness of the first color filters, T2 is equal to the average thickness of the second color filters, T3 is equal to the average thickness of the third color filters.

5. A method for manufacturing a liquid crystal display having a liquid crystal material sandwiched between a pair of substrates, one of the pair of substrates being provided with a plurality of spacers for maintaining a cell gap between the pair of substrates and a plurality of first and second color filters, the method comprising the steps of:
estimating an optimum quantity of the liquid crystal material by measuring a cell volume defined between the pair of substrates;
applying an adhesive onto at least one of the pair of substrates;
dispensing the liquid crystal material to at least one of the pair of substrates, wherein the quantity of the dispensed liquid crystals is controlled based on the estimated optimum quantity;
superposing one of the pair of substrates upon the other substrate; and
curing the adhesive to obtain the liquid crystal display.

6. The method as claimed in claim 5, wherein the cell volume is estimated by measuring the height of the spacers, the thickness difference between the first color filters and the second color filters, and the distance between two adjacent color filters.

7. The method as claimed in claim 5, wherein the liquid crystal display further comprises a plurality of third color filters on the substrate on which the first and second color filters are provided, and, if all of the spacers are provided on the first color filters, the cell volume is estimated by measuring the height of the spacers, the thickness difference between the first color filters and the second color filters, the thickness difference between the first color filters and the third color filters, and the distance between two adjacent color filters.

8. The method as claimed in claim 7, wherein, if only the first, second and third color filters are provided in the liquid crystal display, the optimum quantity of the liquid crystal material is proportional to the value calculated by the equation:
W1*H*L+W2*(H+(T1−T2))*L+W3*(H+(T1−T3))*L+(W13+W12+W23)*D*L
where W1 is equal to the average width of the first color filters, W2 is equal to the average width of the second color filters, W3 is equal to the average width of the third color filters, H is equal to the average of the measured heights of the spacers, L is equal to the average length of the color filters, T1 is equal to the average thickness of the first color filters, T2 is equal to the average thickness of the second color filters, T3 is equal to the average thickness of the third color filters, W13 is equal to the average distance between the first color filters and the third color filters, W12 is equal to the average distance between the first color filters and the second color filters, W23 is equal to the average distance between the second color filters and the third color filters, D is equal to the distance between the pair of substrates.

9. The method as claimed in claim 5, wherein the liquid crystal display further comprises a plurality of third color filters on the substrate on which the first and second color filters are provided, and, if all of the spacers are provided on the first color filters, the cell volume is estimated by measuring the height of the spacers, the average volume of the spacers, the thickness difference between the first color filters and the second color filters, the thickness difference between the first color filters and the third color filters, and the distance between two adjacent color filters.

10. The method as claimed in claim 9, wherein, if only one spacer is provided on each of the first color filters and only the first, second and third color filters are provided in the liquid crystal display, the optimum quantity of the liquid crystal material is proportional to the value calculated by the equation:
W1*H*L+W2*(H+(T1−T2))*L+W3*(H+(T1−T3))*L+(W13+W12+W23)*D*L−
where W1 is equal to the average width of the first color filters, W2 is equal to the average width of the second color filters, W3 is equal to the average width of the third color filters, H is equal to the average of the measured heights of the spacers, L is equal to the average length of the color filters, T1 is equal to the average thickness difference between the first color filters and the second color filters, T2 is equal to the average thickness difference between the first color filters and the third color filters, W13 is equal to the average distance between the first color filters and the third color filters, W12 is equal to the average distance between the first color filters and the second color filters, W23 is equal to the average distance between the second color filters and the third color filters, D is equal to the distance between the pair of substrates, P is the average volume of the spacers.
